(19) United States
(12) Patent Application Publication
(10) Pub. No.: US 2008/0290070 A1
(43) Pub. Date: Nov. 27, 2008

(54) METHOD FOR MANUFACTURING MULTI-PITCH FLASHING

(76) Inventors: Donald P. Fleming, Homewood, AL (US); George D. McLean, Trussville, AL (US)

Correspondence Address: PATENT DOCKET ADMINISTRATOR;LOWENSTEIN SANDLER PC, 65 LIVINGSTON AVENUE, ROSELAND, NJ, 07068, US

(21) Appl. No.: 11/753,676

(22) Filed: May 25, 2007

(51) Int. Cl. B23K 31/02; B23K 9/167

(52) U.S. Cl. 219/61

(57) ABSTRACT

A method for manufacturing lead flashing for a roof pipe is disclosed. A lead pipe is straightened and then pushed into a frictionally engaged knurled clamp. Pressure is applied between a knurled head of a knurler and the inner surface of the lead pipe and the knurler is rotating about the inner surface of the lead pipe. This causes the lead pipe to conform to the knurles of the knurled clamp and the knurled head, while causing a portion of the lead pipe extending beyond the knurled clamp to be contoured and swaged into a flange. At a multi-position horizontally positioned rotatable table, the flange of the knurled lead pipe is flattened to overlap a flat lead sheet having a hole cut from its center. The knurled lead pipe flange and flat lead sheet are arc-welded together with a TIG weld gun. After welding, the finished lead pipe flashing is moved onto a packaging feed conveyor via a vacuum lifter.

### FIELD OF THE INVENTION

The present invention relates generally to flashing, and more particularly to a method for manufacturing the flashing used for roof pipes.

### BACKGROUND OF THE INVENTION

In the construction industry, a wide variety of roofing applications in the commercial, industrial, and residential construction industries have led to the need for flashing devices and materials for protecting roofing structures from the elements, such as water, ice, and dust. Flashing is commonly used at locations where a pipe passes through the roof. The flashing prevents rain water from running down the outside of the pipe and leaking into the building. Flashing for a pipe typically comes in the form of cylindrical sleeve made of lead and having an inner diameter that is slightly greater than the pipe being protected. The cylindrical sleeve is attached to a flat sheet, also made of lead, with a circular hole punched from it, which is joined to the cylindrical sleeve.

The junction between the flat sheet and the cylindrical sleeve is often sealed by overlapping the two and welding them together. Welding is often done by melting the flat sheet and the cylindrical sleeve and adding a filler material to form a pool of molten material that cools to become a strong joint. In some cases, pressure is used in conjunction with heat, or by itself, to produce the weld. This is in contrast with soldering and brazing, which involve melting a lower-melting point material between the work pieces to form a bond between them. Many different energy sources can be used for welding, including oxy-acetylene gas, an electric arc, a laser, an electron beam, friction, and ultrasound.

The joint between the flat sheet and the cylindrical sleeve is conventionally formed by a manual process wherein an operator places the flat sheet (with the cylindrical sleeve standing on it in a desired location) on a horizontally oriented, rotating table. The operator uses a torch to melt, a bar of lead or solder to form a bead of supplementary lead or solder completely around the cylinder at its juncture with the flat sheet. This method suffers from the problem of the creation of a hole if the speed of rotation is too slow or the torch is held too close, if the operator tries to avoid holes by permitting the table to rotate too fast or keeping the torch too far from the juncture, fusion between the supplementary metal and the lead sheet and cylindrical sleeve being joined will not occur.

Another method for welding flat sheets to cylindrical sleeves for producing flashing is disclosed in U.S. Pat. No. 4,742,204 to Canter, Jr. et al. (hereinafter “Canter”) in Canter, a lead sheet and a lead cylinder are positioned on a rotatable table having a cylindrical mandrel extending therefrom and positioned at an angle of 45 degrees with the horizontal. The cylinder is first given a flared edge at the end to be joined and a mating flared edge is produced on the lead sheet by forcing it against a conical form at the juncture of the table and mandrel. A cylinder having a conical cutout at its bottom is pounded against the joint to make the flare and to eliminate any air pockets between the surfaces to be joined, also at a 45 degree angle. While the table is rotated, an electric arc is struck between an electrode and the joint. The electric arc is maintained through a complete revolution of the table so that fusion occurs between the flared portion of the flat sheet and the flared portion of the cylinder around the entire joint. This method suffers from the awkward positions of the table and the workpieces, which are angled at 45 degree with respect to the horizontal, and therefore do not lend themselves to automatic mass production.

Accordingly, what would be desirable, but has not yet been provided, is a method for effectively and automatically producing a lead flashing for a roof pipe that lends itself to mass production without the intervention of an operator during the welding process.

### SUMMARY OF THE INVENTION

The above-described problems are addressed and a technical solution is achieved in the art by providing a method for manufacturing a pipe flashing, comprising the steps of applying pressure between a knurled head of a knurler and an inner surface of a pipe; rotating the knurled head about the inner surface of the pipe so as to cause the pipe to conform at least in part to at least one knurl of the knurled head, while causing a portion of the pipe to be formed into a flange; placing a flat sheet having a hole on a horizontally positioned rotatable table; placing the pipe on the flat sheet with the flange overlying the hole; applying pressure to and rotating the wheels of a flange roller over the flange, thereby flattening the flange upon the flat sheet; and welding the flange to the flat sheet to produce the pipe flashing. The pipe and flat sheet can be made of lead. The type of welding employed can be arc-welding.

The pipe is first straightened and trimmed on a 3-roll straightener. Then the pipe is transferred to the station where the knurler is located using an indexing entry conveyor which can accommodate a plurality of pipes simultaneously. Alter the knurling step, the pipe is transferred by lowering the pipe onto a cradle of an indexing discharge conveyor and then pivoting the pipe pneumatically to an upright position so that the pipe is stood up on its flanged end and deposited onto an articulated belt of the transfer conveyor, where it is moved to within the vicinity of a multi-position horizontally positioned rotatable welding table. A tungsten inert gas (TIG) weld gun is used to produce an electric arc for welding the flange of the now knurled pipe onto the flat sheet. A means is provided for flushing the area of the electric arc with an inert gas. After welding, the finished pipe flashing is moved onto a packaging feed conveyor via a vacuum lifter.

### BRIEF DESCRIPTION OF THE DRAWINGS

The present invention will be more readily understood from the detailed description of exemplary embodiments presented below considered in conjunction with the attached drawings, of which;

FIG. 1 is a perspective view of the parts to be welded as well as perspectives of the parts at various stages of manufacture, constructed in accordance with an embodiment of the present invention;

FIG. 2 is a side view of a 3-roll straightener used to straighten and cut a full length pipe in accordance with straightening step of the present invention;

FIG. 3 is a side view of a plurality of conditioned pipes being inserted onto an indexing entry conveyor in accordance with a conveying step of the present invention;

FIG. 4 depicts a pipe shown in profile within the V-trough, placed in a position for cutting and knurling steps of the present invention;

FIG. 5 depicts how a knurler is advanced within a pipe according to a knurling step of the present invention;

FIG. 6 depicts how a knurl forming roller moves horizontally sideways and nests into the knurls of the knurled clamp during the knurling step of the present invention;

FIG. 7 depicts how the knurler is retracted at the end of the knurling step of the present invention;

FIG. 8 is side view of the finished knurled pipe being lowered onto a cradle of an indexing discharge conveyor according to a second conveying step of the present invention;

FIG. 9 depicts how air gaps between the knurled pipe flange and the sheet can be removed according to a flattening step of the present invention;

FIG. 10 shows the flattened knurled pipe and sheet during a welding step of the present invention; and

FIG. 11 depicts the finished product being moved to a packaging belt conveyor according to a third conveying step of the present invention.

It is to be understood that the attached drawings are for purposes of illustrating the concepts of the invention and may not be to scale.

### DETAILED DESCRIPTION OF THE INVENTION

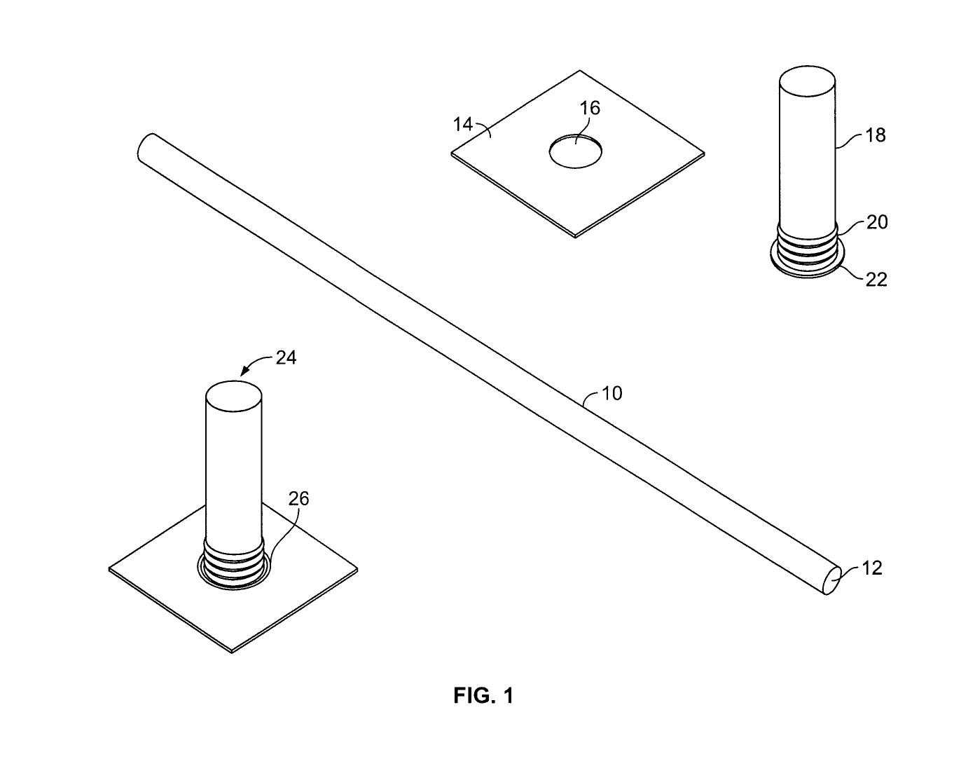

Referring now to FIG. 1, there is shown a full length lead pipe 10 (labeled Part #1) having an inner opening 12, and a flat lead sheet 14 (labeled Part #3) having a hole 16 at its center. The lead pipe 10 is to be shaped and then welded (preferentially TIG welded) to the sheet 14 at the position of the hole 16 such that the inner opening 12 of the pipe 10 lines up with the hole 16 of the lead sheet 14. While the present invention is discussed in the context of a cylindrically-shaped lead pipe, a person skilled in the art would appreciate that the present invention is applicable to hollow pipe flashing of any size, shape, and cross section. The pipe 10 and the sheet 14 are also not limited to lead, but can be made of any suitable material capable of being welded. According to an embodiment of the present invention, a finished pipe 18 (Labeled Part #2) is fashioned from the lead pipe 10 using a Multi-Pitch Flashing Machine to be described below. The lead pipe 10 is straightened, cut, and knurled at one end 20 to a desired shape. A flange 22 is then formed and flattened at the same end 20 to aid in assembly with the sheet 14. The finished product 24 shows the finished pipe 18 welded to the sheet 14, the finished pipe 18 being fused to the sheet 14 by a weld seam 26 about its outer perimeter.

A Multi-Pitch Flashing Machine (not shown) used to assemble the lead pipe 10 to the sheet 14 info a finished product 24 is commonly known as a “PLC; Controlled Special Purpose Machine”. The machine is computer controlled and having user enterable parameter setting so as to allow for the assembly of various lengths and sizes of lead pipe, lead sheet and lead thicknesses. In addition, feed speeds, conveyor speeds, weld speeds and timed pauses can be manipulated. The machine includes several position stations and conveyors such that a plurality of pipes and sheets can be manipulated simultaneously at various steps in the assembly process. The machine is built to handle from about 2¼″ inner diameter (I.D.) to about 4¾″ I.D. lead pipe, wall thicknesses of between about 0.042″ and 0.062″, and lead sheet up to about 12″ square, although the present invention is not specifically limited to pipes and sheets having these ranges of dimensions.

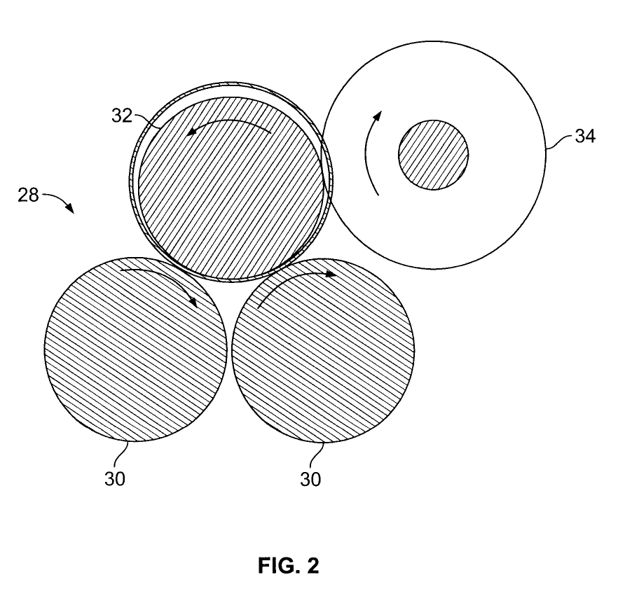

Referring now to FIG. 2, the 3-roll straightener 28 of the Multi-Pitch Flashing Machine is used to straighten and cut the full length lead pipe 10. The straightener 28 includes a plurality of bottom working rollers 30, a mandrel 32, and a slitter trim knife 34. In operation, the full length lead pipe 10 is inserted over the mandrel 32 of the 3 roll straightener 28, the pipe 10 being pushed with enough force such that the pipe 10 meets an end stop (not shown) of the mandrel 32. The straightener 28 is closed and motor power is applied to the rollers 30. At the same time, pressure is applied to the slitter trim knife 34 to cut off excess length from the full length lead pipe 10. The excess lead that is removed is the only scrap produced from the process and is 100% recyclable. The cut pipe is removed from the straightener 28. The straightening process induces hoop stress into the lead pipe 10 and renders the pipe more rigid and thus better able to maintain its shape than before it was conditioned.

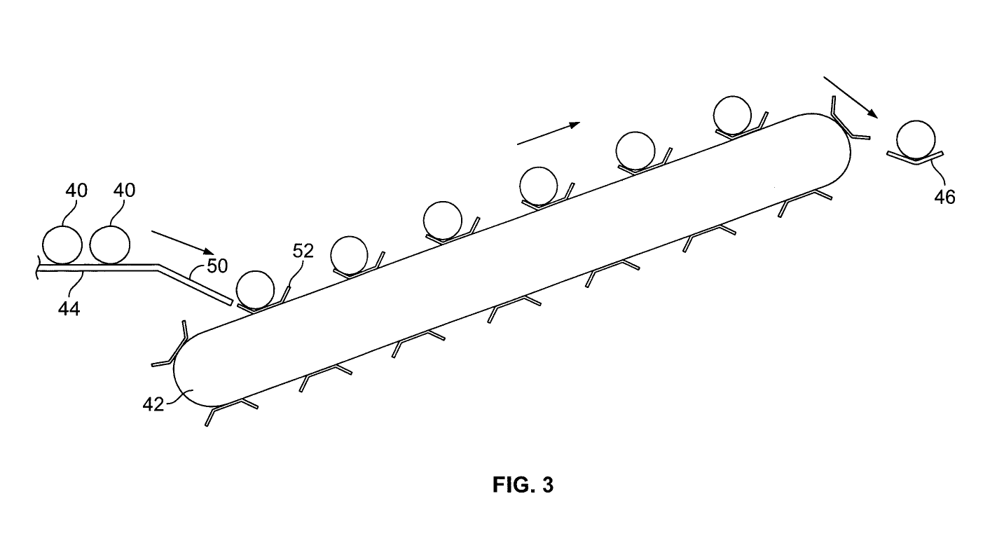

Referring now to FIG. 3, a plurality of conditioned pipes 40 are inserted one by one onto an indexing entry conveyor 42 from a table 44 and which empties the conditioned pipes 40 onto a V-trough 46. When one of the plurality of conditioned pipes 40 leaves the straightener, 28, the conditioned pipe 40 is placed on the table 44 in front of the indexing entry conveyor 42. From there, the pipe 40 is rolled down a slope 50 on the table 44 and onto a U-carrier 52 that has been automatically indexed into position. The conveyor 42 conveys a specific distance (indexes) so that the U-carrier 52 carries a conditioned pipe 40 and loads it onto the Multi-Pitch Flashing Machine V-trough 46. The indexing conveyor 42 can be ‘paused’ by the operator to prevent it from indexing while the operator is loading a pipe. As the U-carrier 52 rounds the end of the conveyor 42, the conditioned pipe 40 rolls onto the V-Trough 46.

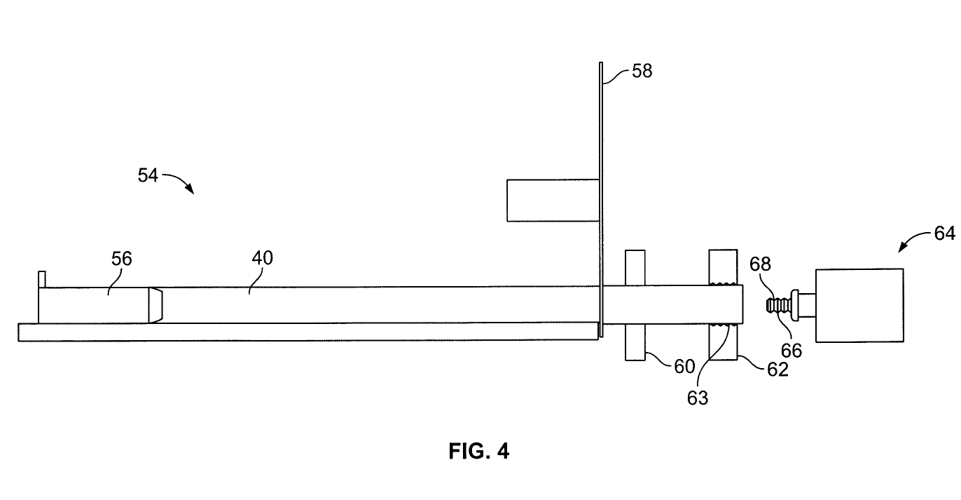

Referring now to FIG. 4, the pipe 40 is shown in profile within the V-trough 46 where it is placed in a position for the cutting and knurling steps to be described hereinafter. The assembly 54 includes a pipe pusher 56, a saw blade 58, a plain clamp 60, a knurled clamp 62, and a knurler 64. The knurler 64 includes a knurl head 66 and a knurl forming roller 66. The knurled head 66 includes a plurality of knurls 68. In operation, the V-Trough is placed between the pipe pusher 56 at one end and the clamps 60, 62 at the other end. The pipe pusher 56 pushes the pipe 40 through the plain clamp 60 and the knurled clamp 62, which has a plurality of knurls 63. The clamps 60, 62 are closed and grip the pipe 40 while the saw blade 58 cuts the pipe 40 at a pre-determined distance from the location of the knurled clamp 62. The location where the saw blade 58 cuts the pipe 40 determines the height of the finished knurled lead pipe (see Part # 2 of FIG. 1).

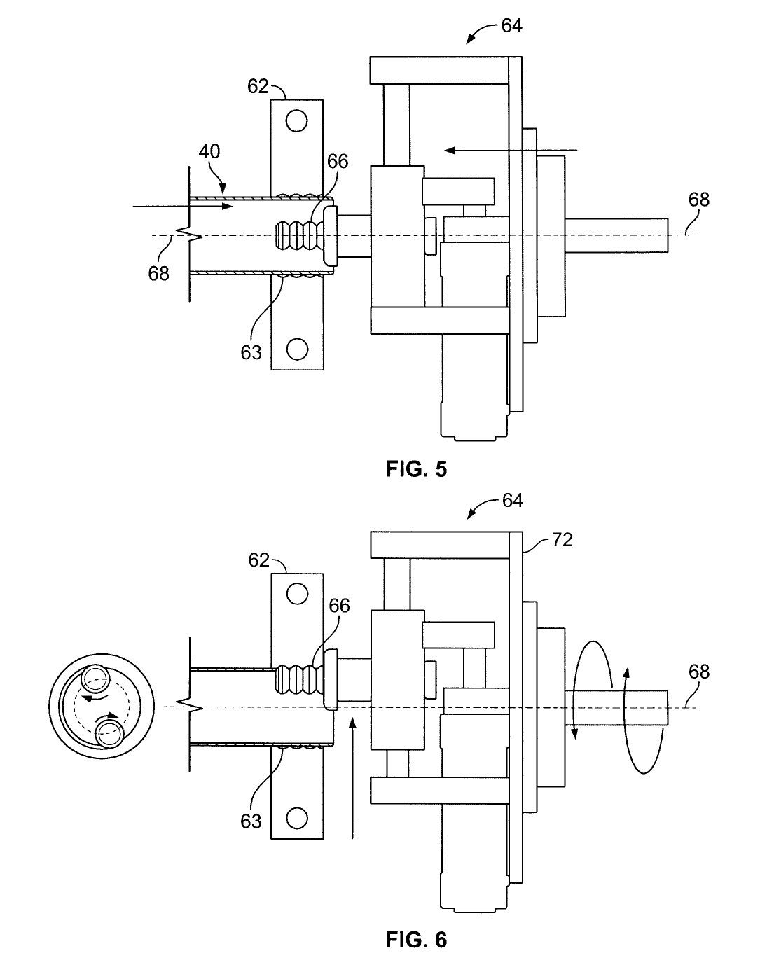

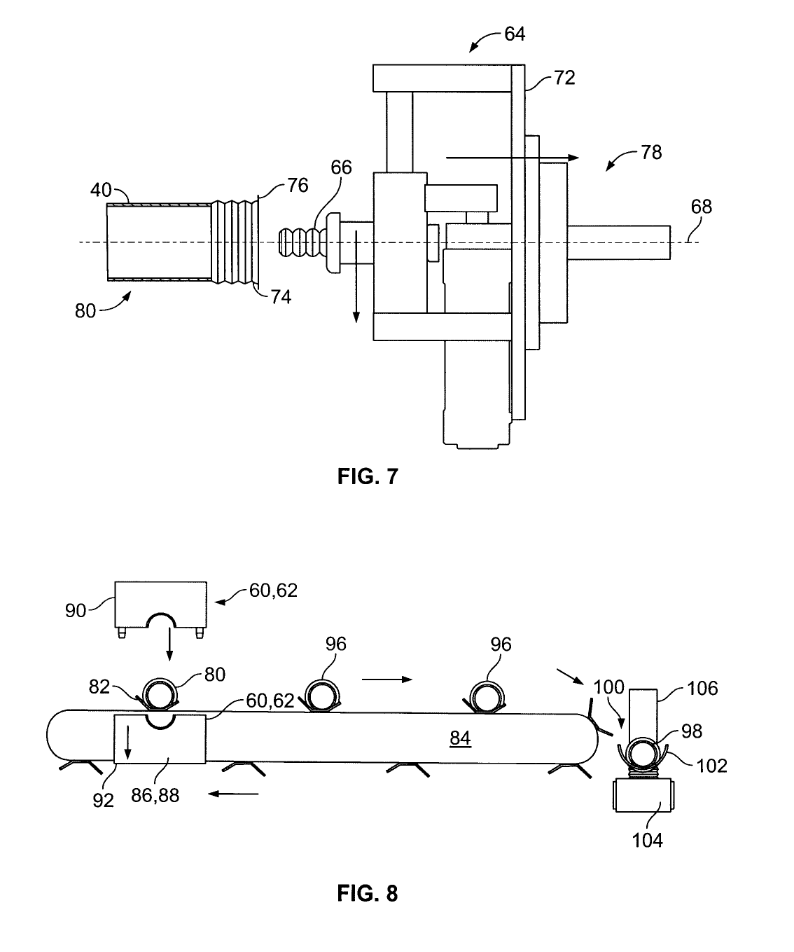

Referring now to FIGS. 5-7, the step of “knurling” one end of the pipe 40 is depicted. The knurl head 66 or the knurler 64 is advanced linearly along a centerline 68 of the lead pipe 40 positioned within the knurled clamp 62. The knurl forming roller 66 is precisely positioned inside the lead pipe 40 such that knurls 68 of the knurl head 66 are aligned with the knurls 63 of the knurled clamp 62. The length of the lead pipe 40 extending beyond the knurled clamp 62 (as positioned by the pipe pusher 56 in FIG. 4) can be manipulated so that an optimum knurl flange spread diameter can be obtained.

In operation, the knurl forming roller 66 moves horizontally sideways and nests into the knurls 63 of the knurled clamp 62. The knurl forming roller 66 is mounted in ball bearings (not shown) and is able to rotate freely. The machine elements 72 that hold the knurl forming roller 66 rotate a full 360 degrees clockwise and then 360 degrees counterclockwise, causing the knurl forming roller 66 to roll around the inside of the pipe 40 in an orbital fashion. Pneumatically cushioned pressure applied sideways to the knurl forming roller 66 causes the inside of the pipe 40 to conform to the knurl shape of the knurled clamp 62. Simultaneously, a portion 74 of the pipe 40 extending beyond the knurled clamp 62 is contoured and swaged into a knurled pipe flange 76. After rotating clockwise and counterclockwise, the knurl forming roller 66 retracts sideways to its centerline position and the knurl head 66 retracts linearly to a position 78 clear of the finished knurled pipe 80.

Referring now to FIG. 8, with the knurl forming roller 66 retracted, the finished knurled pipe 80 is lowered onto a cradle 82 of an indexing discharge conveyor 84 where the lower portions 86, 88 of the plain clamp 60 and knurled clamp 62, respectively, drop beyond the position of the cradle 82. The discharge conveyor 84 indexes and carries the finished knurled pipe clear of the clamp halves 90, 92. A plurality of finished pipe parts 80, 96 can accumulate on the discharge conveyor. Another finished knurled pipe 98, as it rounds the end 100 of the discharge conveyor 84, rolls into another cradle 102 of a transfer conveyor 104. The cradle 102 is pivoted pneumatically to an upright position 106 so that the finished knurled pipe 98 is stood up on its Hanged end and deposited onto an articulated belt (not shown) of the transfer conveyor 104. The transfer conveyor 104 transfers the finished knurled pipe within reach of a weld station.

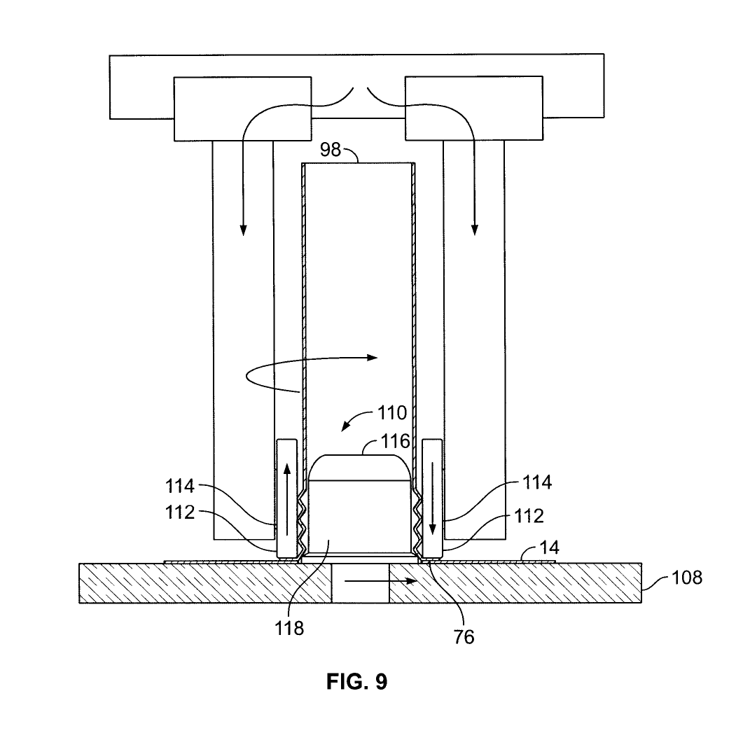

Referring now to FIG. 9, the flat lead sheet 14 and the finished knurled pipe 98 are moved to the weld station which includes a horizontally-oriented rotatable welding table (not shown), a rotatable copper platen 108 having a platen spigot 110 extending therefrom, pneumatically cushioned and pressured flange rollers 112, and driving wheels 114. The flat lead sheet 14 and the finished knurled pipe 98 are loaded over the platen spigot 110. The platen spigot 110 has a locating shoulder 116 to locate the lead sheet 14 and has a shank 118 for locating the finished knurled pipe 98. The location shoulder 116 and the shank 118 are sized and shaped to allow for easy placement of the parts, yet are capable of locating the parts within specifications. Before welding, air gaps that that may be present between the knurled pipe flange 76 and the lead sheet 14 can be removed. This is done by lowering the pneumatically cushioned and pressured flange rollers 112 onto the rotatable copper platen 108 with the knurled pipe flange 76 and the lead sheet 14 sandwiched therebetween. The free wheeling rotatable copper platen 108, while rotating into a new position, comes in contact with driving wheels 114 which spin on the periphery of the rotatable copper platen 108 and cause it to rotate. The driving wheels 114 are driven by computer controlled servomotors (not shown).

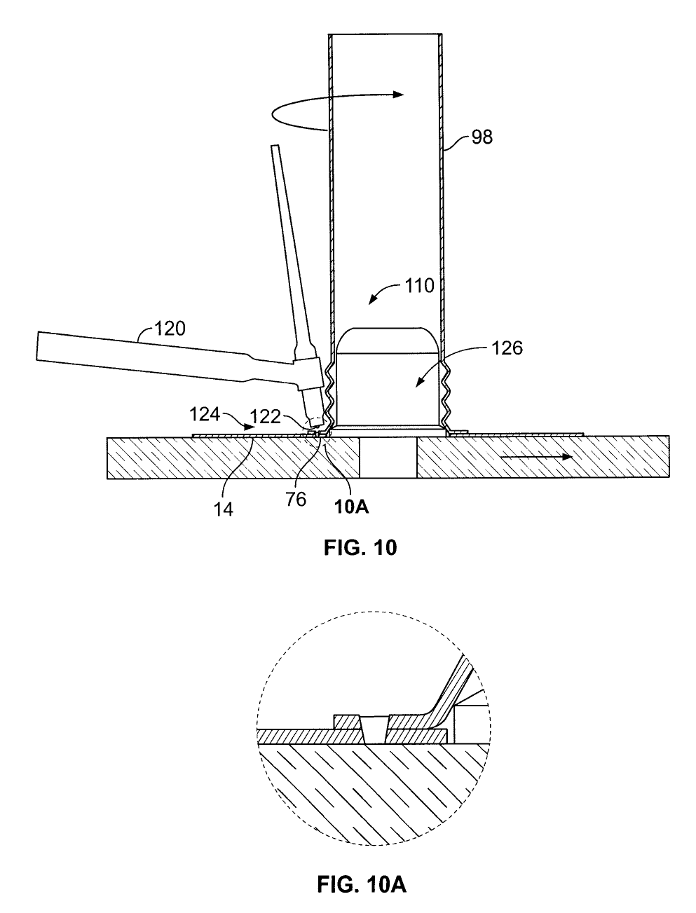

Referring now to FIG. 10, the weld station also includes a TIG weld gun 120. The weld gun 120 operates on the principle of providing an electric arc to the materials to be welded without the use of a solder as shown in the inset diagram of FIG. 10. The electrode 122 of the TIG weld gun 120 is water cooled to prevent the weld gun 120 from overheating. The TIG weld gun is also provided with an inert, gas chamber (not shown) for inundating the welding area of the arc with an inert, gas, such as argon, to prevent oxygen and other air elements from contaminating the electrode 122 and the welded materials. In operation, when the knurled pipe flange 76 is flattened to remove air gaps as depicted in FIG. 9, the TIG weld gun 120 is moved to a position 124 where the flattened knurled pip flange 76 and the lead sheet 14 overlap. When welding commences, an electric arc (not shown) jumps from a positive electrode (the weld gun 120) to ground (position 124). The heat generated locally at the arc point (i.e., the position 124) fuses the flattened knurled pip flange 76 and the lead sheet 14. During the welding step, the parts 76, 14 are rotating about the center 126 of the platen spigot 110, so that the weld forms a circular path. When the welding operating has proceeded for a full 360 degree rotation of parts 76, 14, welding ceases. During welding, the area in the vicinity of the position 124 of the arc is flushed with inert gas. Since the weld speed is critical to weld properties, the rotational speed of the platen is set to match the predetermined weld speed that is required.

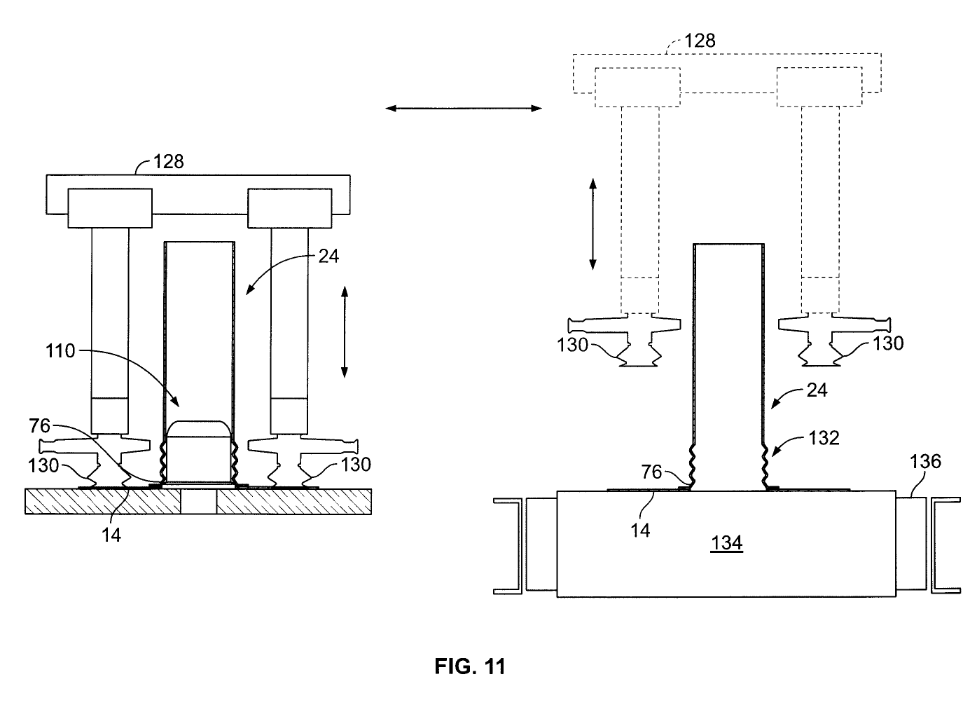

Referring now to FIG. 11, the welded parts 76, 14 now form the finished product 24. The rotatable welding fable moves the finished product 24 to a final position (while other parts are moved into prior positions on the rotatable welding table). A vacuum lifter 128 having vacuum cups 130 is lowered onto the lead sheet portion 14 of the finished product 24 and a vacuum is applied. The finished product 24 is raised over the height of the platen spigot 110. The vacuum lifter 128 then transfers the finished product 24 from the rotatable welding table to a position 132 over a packaging feed conveyor 134. The finished product 24 is lowered and dropped a short distance onto the moving belt 136 of the feed conveyor 134. When the finished product 24 is sufficiently clear of the vacuum Sifter 128, the vacuum lifter 128 returns to its last position over the rotatable welding table before the next finished part is rotated (indexed) into the final position.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A method for manufacturing a pipe flashing, comprising the steps of:
applying pressure between a knurled head of a knurler and an inner surface of a pipe;
rotating the knurled head about the inner surface of the pipe so as to cause the pipe to conform at least in part to at least one knurl of the knurled head, while causing a portion of the pipe to be formed into a flange;
placing a flat sheet having a hole on a horizontally positioned rotatable table;
placing the pipe on the flat sheet with the flange overlying the hole;
applying pressure to and rotating the wheels of a flange roller over the flange, thereby flattening the flange upon the flat sheet; and
welding the flange to the flat sheet to produce the pipe flashing.

2. The method of claim 1, further comprising the step of locating the pipe and the hole of the flat sheet on the table by means of a rotating platen having a platen spigot extending therefrom.

3. The method of claim 1, wherein the pipe and flat sheet are made of lead.

4. The method of claim 1, wherein said step of welding the flange includes the step of welding the flange with an electric arc.

5. The method of claim 4, wherein said step of welding further comprises the step of flushing the vicinity of the electric arc with an inert gas.

6. The method of claim 4, further comprising the step of applying suction to cups of a vacuum lifter so as to attach the cups to the finished flashing.

7. The method of claim 6, further comprising the step of transferring the finished flashing to a packaging feed conveyor.

8. The method of claim 4, further comprising the step of providing a TIG weld gun to produce the electric arc.

9. The method of claim 8, further comprising the step of transferring the pipe from a first position on the horizontally positioned rotatable welding table where said step of applying pressure to and simultaneously rotating the wheels of a flange roller is effected to a second position on the horizontally positioned rotatable welding table where said step of welding is effected.

10. The method of claim 9, wherein said step of applying pressure to and rotating the wheels of a flange roller is effected on one pipe/flat sheet pair at the same time said step of welding is effected on a second pipe/flat sheet pair on said horizontally positioned rotatable welding table.

11. The method of claim 1, further comprising the steps of:
lowering the pipe onto a cradle of an indexing discharge conveyor;
causing the lower portion knurled clamp to drop beyond the position of the cradle;
rolling the pipe into a cradle of a transfer conveyor; and
pivoting the pipe pneumatically to an upright position so that the pipe is stood up on its flanged end and deposited onto an articulated belt of the transfer conveyor.

12. The method of claim 11, further comprising the step of accumulating a plurality of finished pipe parts on the discharge conveyor.

13. The method of claim 1, further comprising the steps of inserting the pipe over a mandrel of a 3-roll straightener and straightening the pipe with the 3-roll straightener before said step of applying pressure between a knurled head of a knurler and the inner surface of a pipe.

14. The method of claim 13, further comprising the steps of inserting the pipe onto an indexing entry conveyor after said step of straightening said pipe on the 3-roll straightener and emptying the onto a V-trough before said step of applying pressure between a knurled head of a knurler and the inner surface of a pipe.

15. The method of claim 14, further comprising the step of loading a plurality of pipes on said indexing entry conveyor.
